(19) United States
(12) Patent Application Publication
(10) Pub. No.: US 2004/0098311 A1
(43) Pub. Date: May 20, 2004

(54) XML message monitor for managing business processes

(76) Inventors: Rajan Nair, Manalapan, NJ (US); Raghu Rajagopal, North Brunswick, NJ (US); Aravind Ramachandran, Dayton, NJ (US)

Correspondence Address: DEMONT & BREYER, LLC, SUITE 250, 100 COMMONS WAY, HOLMDEL, NJ, 07733, US

(21) Appl. No.: 10/295,572

(22) Filed: Nov. 15, 2002

(51) Int. Cl. G06F 17/60

(52) U.S. Cl. 705/26

(57) ABSTRACT

An apparatus for monitoring XML messages within a business process is disclosed. The illustrative embodiments allow a user to define rules and export these rules to a business process management platform, where they can be embedded within a business process. XML messages that are part of the business process (e.g., between an inventory application and a sales forecasting application, etc.) are automatically intercepted and matched against the appropriate rule. When a message matches a rule, the rule's actions are executed and an XML return value is returned to the business process management platform.

### FIELD OF THE INVENTION

The present invention relates to enterprise software systems in general, and, in particular, to an XML message monitor for use in conjunction with business process management and integration systems.

### BACKGROUND OF THE INVENTION

As the variety of specialized enterprise software systems (e.g., customer relationship management [CRM], enterprise resource planning [ERP], supply-chain management [SCM], etc.) has proliferated, enterprises face the problem of sharing data between these systems and having them work together to perform various business processes. In addition, due to the increased adoption of collaborative e-business between companies and their suppliers, partners, and customers, it has become necessary for applications across different enterprises to work together.

For example, a supply-chain business process could include some combination of the following tasks:

generating a production schedule

ordering materials from contracted suppliers

verifying receipt of materials

updating the inventory databases

invoice processing

payment

Accordingly, the business process may involve multiple data processing systems, including the manufacturing software system, inventory management system, purchase ordering system, and financial transaction system.

As illustrated by the exemplary business process above, managing a business process involves (i) transaction management, (ii) sharing and communication of data across applications, and (iii) controlling the flow of execution of applications. The following paragraphs discuss each of these issues in turn.

As is well known in the art, a transaction is an atomic (i.e. indivisible) unit of work performed by a data processing system such as a database management system. Consider, for example, a bank transaction in which Mr. Smith transfers $100 from his savings account to his checking account. This transaction involves several steps; first, the savings account balance should be checked to ensure that it is greater than or equal to $100 plus the minimum required balance. If not, then the transaction is not performed; otherwise, $100 should be withdrawn from the savings account, and $100 should be deposited into the checking account.

In the above example, it is apparent that a partially-executed transaction could be problematic. For example, if the above transaction terminated after $100 was withdrawn from the savings account, but before $100 had been deposited in the checking account, then Mr. Smith's total assets at the bank would be incorrect. As computing systems can fail at any time as a result of power failures, server failures, network failures, etc., a failure during the execution of a transaction could result in a partially-completed transaction, thus potentially compromising data integrity. In order to eliminate the potential for such problems, data processing systems employ a transaction manager for ensuring that transactions execute properly in an all-or-nothing fashion. Such transaction managers typically employ commits and rollbacks, as is well understood in the art, to achieve this functionality.

A second aspect of business process management is controlling the flow of execution of the applications participating in a business process. For example, in the supply-chain example described above, the flow of execution for a business process might be:

the manufacturing software system generates a production schedule that forecasts the materials required

the inventory management system checks current inventory and determines that it is too low to accommodate the production schedule

the purchase ordering system sends orders to contracted suppliers

As another example, the flow of execution for a second supply-chain business process might be:

the inventory management system verifies receipt of materials

the inventory management system updates the inventory databases

the financial transactions system performs invoice processing

the financial transactions system makes electronic payments to the appropriate suppliers

One possible approach for controlling the flow of execution among multiple applications is to embed custom protocols within each application through which the applications can communicate and coordinate execution. This approach, however, is not a viable option for applications in which source code is not available. Furthermore, even when source code is available, this approach is difficult and expensive, as it requires protocol development, protocol validation and verification, and time-consuming coding to implement the protocols. As a result, software practitioners realized that it would be beneficial to have a separate piece of software for managing execution flow.

A third aspect of business process management is sharing and communication of data across applications. As is well known in the art, different applications, especially those created by different entities, typically employ different data models and schemas. For example, employee data in a human resources application at a bank is likely to be stored differently (e.g. different database schema, different table and field names, different data formats, etc.) than in a benefits management application at an insurance company providing benefits to the bank's employees. Consequently, sharing data between applications typically requires mapping the data from one schema to another.

One possible approach for implementing such data sharing is to develop custom software for each pair of applications to performing the necessary mapping. As one might expect, this can be a time-consuming and expensive process. Consequently, software practitioners again realized the desirability of a single, separate piece of software for managing data sharing among applications.

A new class of applications, referred to alternatively as Enterprise Application Integration (EAI) platforms, e-Business Application Integration (eAI) platforms, or business process management (BPM) platforms, has emerged as a result. These platforms, current commercial examples of which are WebMethods and TIBCO, facilitate the integration of disparate enterprise applications for performing business processes.

In the prior art, such platforms, referred to henceforth as BPM platforms, typically interact with other enterprise applications via a “hub-and-spoke” or “star” topology. As shown in FIG. 1, exemplary BPM platform 110 is located at the hub, with applications 120-1 through 120-N individually connected to the hub via respective logical links 130-1 through 130-N. Each logical link 130-i, 1≦i≦N. can represents either (i) a physical link in a local area network in which application 120-i and BPM platform 110 reside on different servers; (ii) a communications channel (e.g., socket, etc.) connecting application 120-i and BPM platform 110 when they reside on either the same server or different servers; (iii) a path in an intranet in which application 120-i and BPM platform 110 reside on different servers; or (iv) a path in a wide-area network (WAN) or metropolitan-area network (MAN) in which application 120-i and BPM platform 110 reside on different servers in an intra-enterprise or inter-enterprise extranet.

Applications 120 communicate with each other by sending messages through BPM platform 110. As is well known in the art, messages are typically sent either via (i) an adapter customized for a particular application (e.g., Siebel CRM, etc.), or (ii) a messaging platform such as IBM MQSeries. As is well-known in the art, the current industry standard for the contents of these messages is the eXtensible Markup Language (XML). XML, like the HyperText Markup Language (HTML), is a markup language derived from the Standard Generalized Markup Language (SGML.) Unlike HTML, however, which uses tags to describe how data is presented in a browser, XML uses semantic tags to describe what data it contains.

FIG. 2 depicts the contents of an exemplary XML fragment representing a sales order. As shown in FIG. 2, the sales order comprises: an order identification code; a customer identification code; three order items; the date/time at which the order was placed; the amount of money paid, including currency; order priority; and shipping information. Each order item comprises an item identification code, a unit price, and the quantity ordered. Shipping information comprises an earliest ship date; a promised delivery date; a freight class; and a postal address. The postal address comprises street address, city, county, state/province; country; and postal code.

As is well known in the art, a recent trend in distributed systems is to offer a particular function of an application as a service to other applications and/or services. In particular, web services are services that can be invoked over a network (e.g., intranet, the Internet, etc.), typically by sending messages containing XML via the hypertext transfer protocol (HTTP). Web service clients employ the Simple Object Access Protocol (SOAP) for sending input parameters (defined in XML) to the service, invoking methods, and receiving the results of the service (also defined in XML). For example, the Google search engine can be invoked as a web service from another application or service, thus allowing other applications and services to embed search results in their responses to user requests. Similarly, a stock quote web service could be invoked over the Internet by another application or service, thereby allowing other applications and services to provide such information.

Web services therefore define a standard for loosely-coupled distributed computing over HTTP networks, in which various services can be “exposed” over the Internet for clients to invoke. Since many business processes are in fact composed of loosely-coupled distributed applications, some BPM platforms (e.g., WebMethods, etc.) refer to the constituent applications participating in a business process as “services”, even though the applications might not be formally exposed as a service. Consequently, in the remainder of this disclosure the terms “application” and “service” are used interchangeably, depending on the particular context.

FIG. 3 depicts a block diagram of the salient components of an exemplary BPM platform 110 in the prior art. As depicted in FIG. 3, exemplary BPM platform 110 comprises business process manager 310, business process modeler 320, business process database 330, transaction manager 340, and transaction editor 350, interconnected as shown. Business process manager 310 oversees a business process in business process database 330 by tracking the flow of execution of its constituent tasks, as is well-known in the art. Business process manager 310 invokes transaction manager 340 to manage individual transactions and coordinate multiple transactions at appropriate points within a business process' execution.

Business process modeler 320 allows a user to create and/or edit a business process; typically business process modeler 320 has a convenient graphical user interface (GUI) for creating and/or editing a graphical representation of a business process. Working in conjunction with business process modeler 320 is transaction editor 350. As is well known in the art, transaction editor 350 allows a user to create and/or edit transactions within a business process, and to create and/or edit composite transactions spanning multiple individual transactions.

Business process database 330 stores previously-created business processes; business process modeler 320's GUI allows a user to load a business process from business process database 330 for editing, in well-known fashion, and to save a new or modified business process to business process database 330, also in well-known fashion.

FIG. 4 depicts an exemplary GUI 400 (WebMethods) for business process modeler 320. As shown in FIG. 4, business process modeler GUI 400 comprises service list subwindow 410, flow implementation subwindow 420, and data mapping subwindow 430.

Service list subwindow 410 contains a list of services organized in hierarchy similar to Microsoft Windows Explorer, as in well known in the art. As shown in FIG. 4, the top level of the hierarchy comprises packages, depicted by package icons and names; the next level comprises folders, depicted by folder icons and names; and the final level comprises the individual services, depicted by a service icon and name. Package RealWorld comprises two folders, Application and OrderManagement, and folder Application comprises a service named OrderProcess. The right-arrow icon for service OrderProcess indicates that this service is implemented as a WebMethods “flow” using WebMethods' proprietary “flow language.” As is well understood in the art, a service might also be defined in a standard programming language such as Java or C/C++, and other BPM platforms (e.g., TIBCO, etc.) might use alternative means for defining and implementing services.

Flow implementation subwindow 420 shows the implementation details of a particular service flow; in FIG. 4, flow implementation subwindow 420 depicts the flow implementation details for service OrderProcess. As shown in FIG. 4, service OrderProcess comprises an ordered list of statements. These statements fall into various categories, such as service invocations, denoted by right arrows (e.g., the first two statements, etc.), and branches, denoted by fork icons (e.g., the third statement, etc.) Other kinds of statements, not shown in FIG. 4, include various kinds of looping, jump and exit statements, as are well known in the programming arts.

Data mapping subwindow 430 is for showing the correspondence between data fields in different entities (e.g., in-memory data records, rows in relational database tables, XML documents, etc.) Such correspondences, or mappings, between data fields is a ubiquitous technique in BPM platforms for passing data between different software applications, as is well known in the art. FIG. 4 does not show any mappings in data mapping subwindow 430.

### SUMMARY OF THE INVENTION

The present invention monitors XML messages passed between applications participating in a business process. The illustrative embodiments allow a user to define a rule pertaining to the contents of XML messages, and export the rule to a BPM platform, where it can be incorporated into one or more business processes. A rule comprises a set of conditions, a set of actions to perform when a message matches its conditions, and an XML value to return to the BPM platform; typically the latter is used to notify the BPM platform of the results of the rule's execution. The illustrative embodiments automatically intercept any XML messages that are part of a business process and match the message against the rule specified at the appropriate point within the business process. When a message matches a rule, the rule's actions are executed and the XML return value is sent back to the BPM platform. The BPM platform resumes execution of the business process at the appropriate point, possibly based on the XML return value.

### BRIEF DESCRIPTION OF THE DRAWINGS

FIG. 1 depicts a block diagram of a plurality of software applications connected to a business process management (BPM) platform, in the prior art.

FIG. 2 depicts the contents of an exemplary XML message.

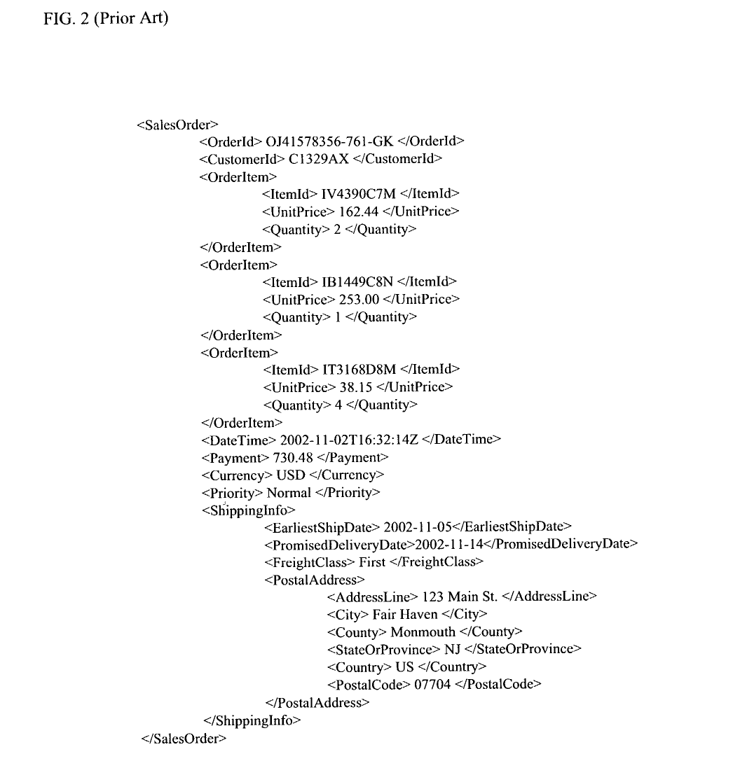

FIG. 3 depicts a block diagram of the structure of BPM platform 110, as shown in FIG. 1, in the prior art.

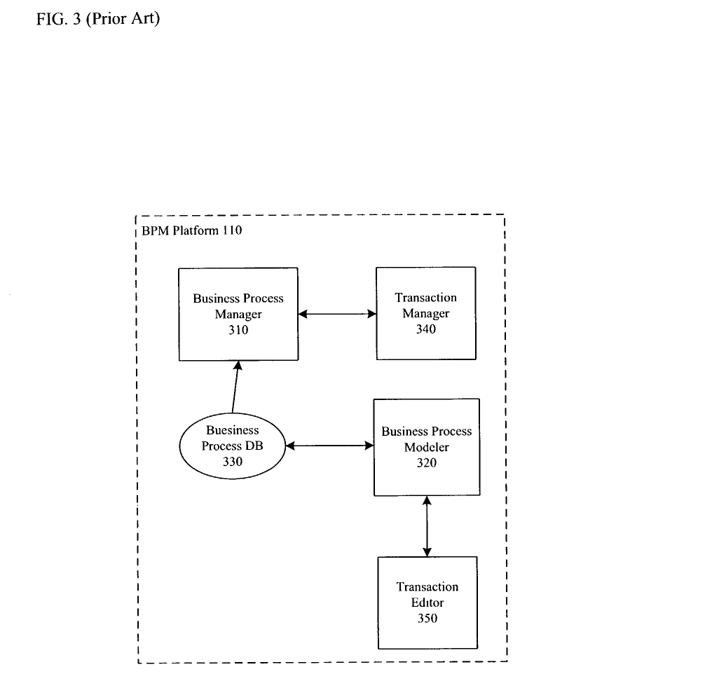

FIG. 4 depicts an exemplary graphical user interface for business process modeler 320, as shown in FIG. 3, in the prior art.

FIG. 5 depicts a block diagram of a plurality of software applications connected to BPM platform 110, as shown in FIG. 1, and XML message monitor 510, in accordance with the illustrative embodiments of the present invention.

FIG. 6 depicts a block diagram of the structure of XML message monitor 510, shown in FIG. 5, and user client 660, in accordance with the first illustrative embodiment of the present invention.

FIG. 7 depicts a block diagram of the structure of XML message monitor 510, shown in FIG. 5, and user client 660, in accordance with the second illustrative embodiment of the present invention.

FIG. 8 depicts an exemplary graphical user interface for managing payloads, in accordance with the illustrative embodiments of the present invention.

FIG. 9 depicts an exemplary graphical user interface for managing events, in accordance with the illustrative embodiments of the present invention.

FIG. 10 depicts an exemplary graphical user interface for managing pipelines, in accordance with the illustrative embodiments of the present invention.

FIG. 11 depicts an exemplary graphical user interface for rule editor 610, as shown in FIG. 6, in accordance with the illustrative embodiments of the present invention.

FIG. 12 depicts an exemplary graphical user interface for mapping payloads, in accordance with the illustrative embodiments of the present invention.

FIG. 13 depicts a first exemplary screen of a graphical user interface for exporter 620, in accordance with the illustrative embodiments of the present invention.

FIG. 14 depicts a second exemplary screen of a graphical user interface for exporter 620, in accordance with the illustrative embodiments of the present invention.

FIG. 15 depicts a third exemplary screen of a graphical user interface for exporter 620, in accordance with the illustrative embodiments of the present invention.

FIG. 16 depicts an exemplary graphical user interface for business process modeler 320, as shown in FIG. 3, in accordance with the illustrative embodiments of the present invention.

### DETAILED DESCRIPTION

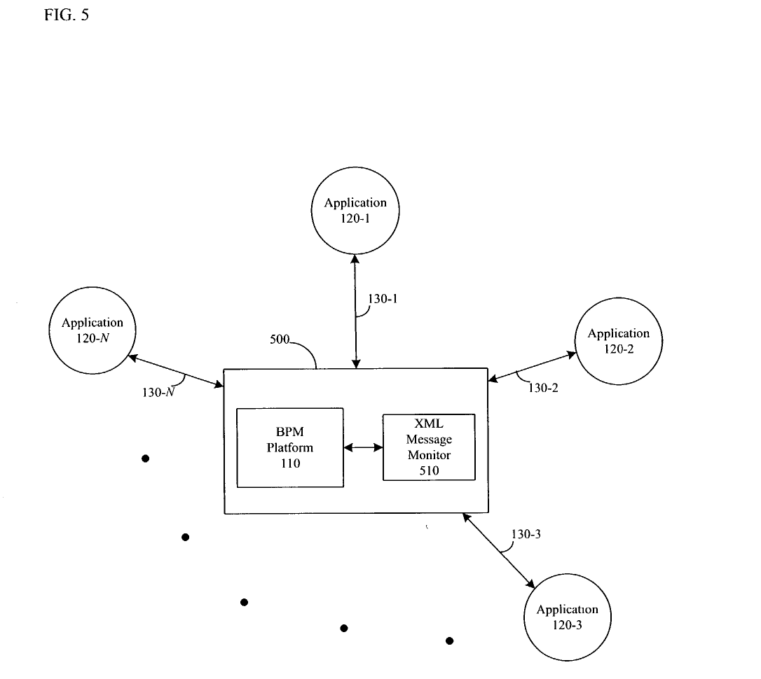

FIG. 5 depicts a block diagram of software applications 120-1 through 120-N interconnected via hub 500 in accordance with the illustrative embodiments of the present invention. As shown in FIG. 5, hub 500 comprises BPM platform 110 and XML message monitor 510. Applications 120-1 through 120-N are individually connected to the hub via respective logical links 130-1 through 130-N. As in the prior art, each logical link 130 can be a physical LAN link, a socket, a MAN path, a WAN path, etc.

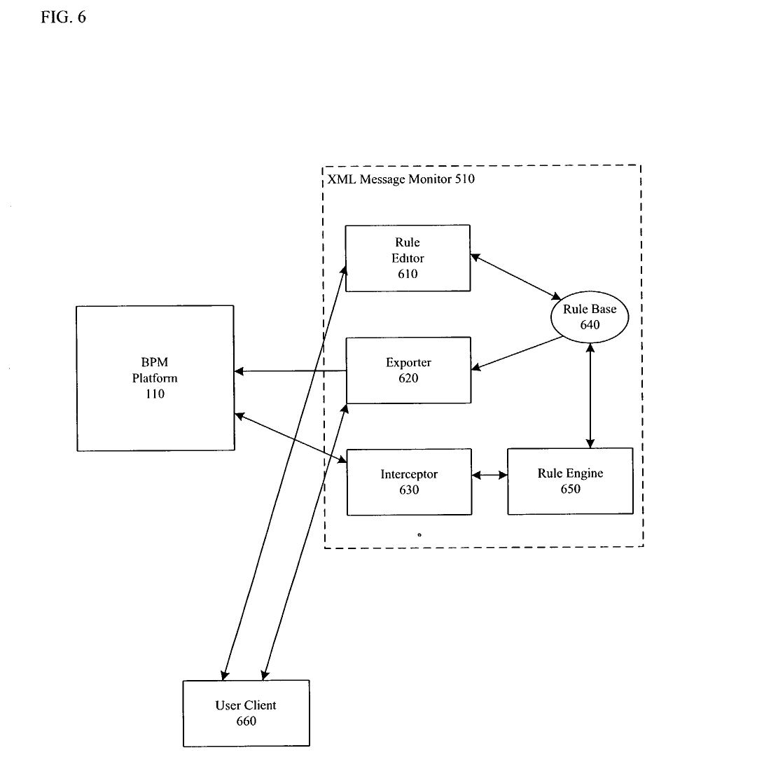

FIG. 6 depicts a block diagram of the salient components of XML message monitor 510 and user client 660, interconnected as shown, in accordance with the first illustrative embodiment of the present invention. XML message monitor 510 comprises rule editor 610, exporter 620, interceptor 630, rule base 640, and rule engine 650.

User client 660 invokes rule editor 610 remotely; this remote access could be via a browser, for example, or via Java RMI (Remote Method Invocation). As will be appreciated by those skilled in the art, user client 660 can invoke rule editor 610 remotely in many different ways, and the illustrated embodiment of the present invention covers those ways as well.

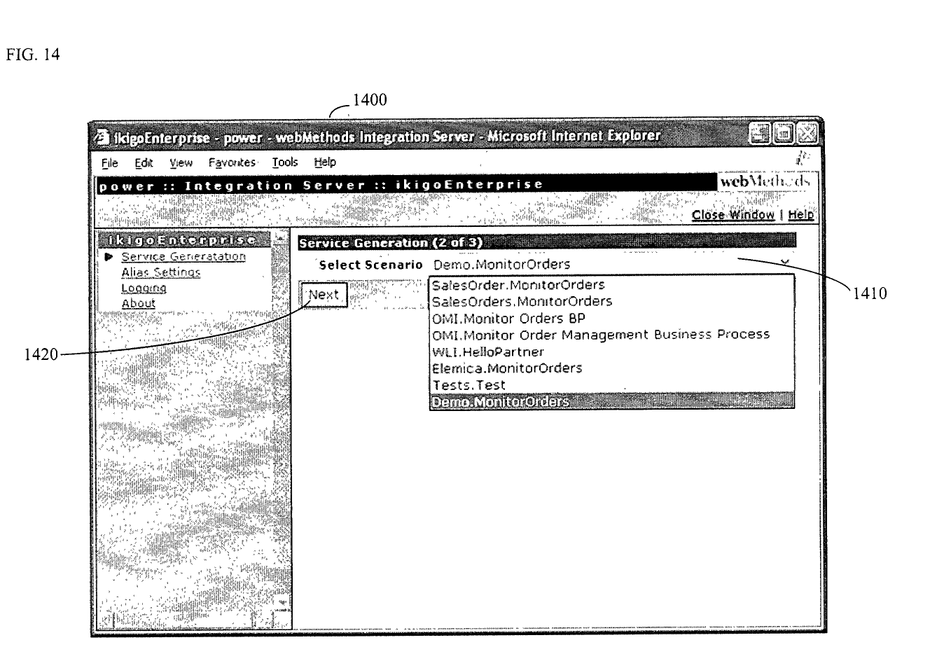

Rule editor 610 allows a user to build new rules, edit existing rules, save rules to rule base 640, load rules from rule base 640, and delete rules from rule base 640. As is well understood in the art, such functionality can be implemented in a manner similar to a word processor (e.g., Microsoft Word, etc.) In some embodiments, rules might be represented textually by “IF/THEN” rules, while in some other embodiments, rules might be represented as subroutines (e.g., methods, procedures, functions, etc.) in a programming language (e.g., Javascript, Perl, etc.), as is well understood in the art. An exemplary graphical user interface for rule editor 610 is disclosed below in the description of FIG. 14.

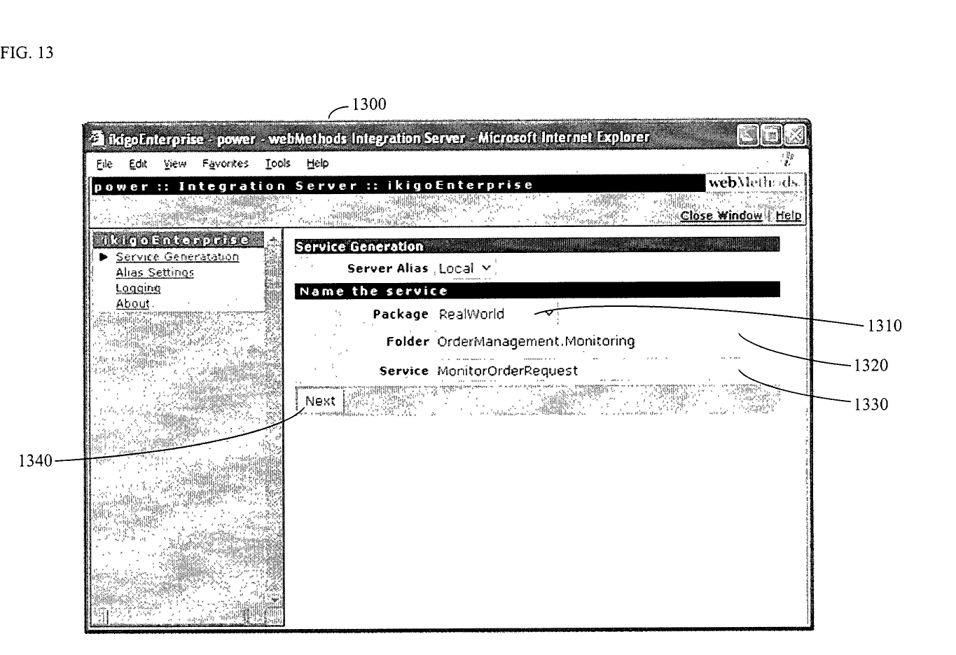

Exporter 620 allows a user to select particular rules from rule base 640 and export these rules to BPM platform 110, where the rules can be embedded in one or more business processes. In some embodiments, exporter 620 creates one or more executable files that correspond to the particular rules, and stores these executables in an appropriate location (e.g., directory, etc.) so that they are accessible from within BPM platform 110. In other embodiments, exporter 620 might create particular objects or files that conform to a proprietary “plug-in” standard or application programming interface (API) of BPM platform 110 in order to make the rules available from within BPM platform 110. An exemplary graphical user interface for exporter 620 is disclosed below in the description of FIGS. 13, 14, and 15.

Recall that in the prior art, messages between applications are sent through BPM platform 110; i.e., BPM platform 110 receives a message from a source application and then forwards the message to the appropriate destination application(s). In the illustrative embodiment of the present invention, however, messages from a source application are intercepted by interceptor 630 before reaching BPM platform 110. Interceptor 630 analyzes the message contents (e.g., checking that the XML content conforms correctly to a particular schema, etc.) and forwards the message, as well as an identifier representing the current rule in the business process, to rule engine 650.

Rule engine 650, using the identifier, retrieves the appropriate rule from rule base 640, and checks whether the message matches the conditions of the rule. If the message does not match, then rule engine 650 forwards the message to BPM platform 110, and BPM platform 110 performs its usual task of forwarding the message to the appropriate destination application(s). If the message does match, then rule engine 650 executes the rule's actions, constructs an XML-based return value as specified in the rule, and sends the XML-based return value and the original message to BPM platform 110. In some embodiments, the original message is embedded with the return value, while in other embodiments, the original message and the return value are sent separately to BPM platform 110.

BPM platform 110 examines the return value and advances the state of the current business process based on the return value. Depending on the return value, advancing the state of the business process could involve any of the following actions:

taking a particular branch in the business process

forwarding the message to the appropriate destination application(s)

terminating the business process

not forwarding the message

sending a message to the source application indicating an error or exception

As will be appreciated by those skilled in the art, these actions are exemplary, and it is in fact possible for BPM platform 110 to perform other actions as appropriate .

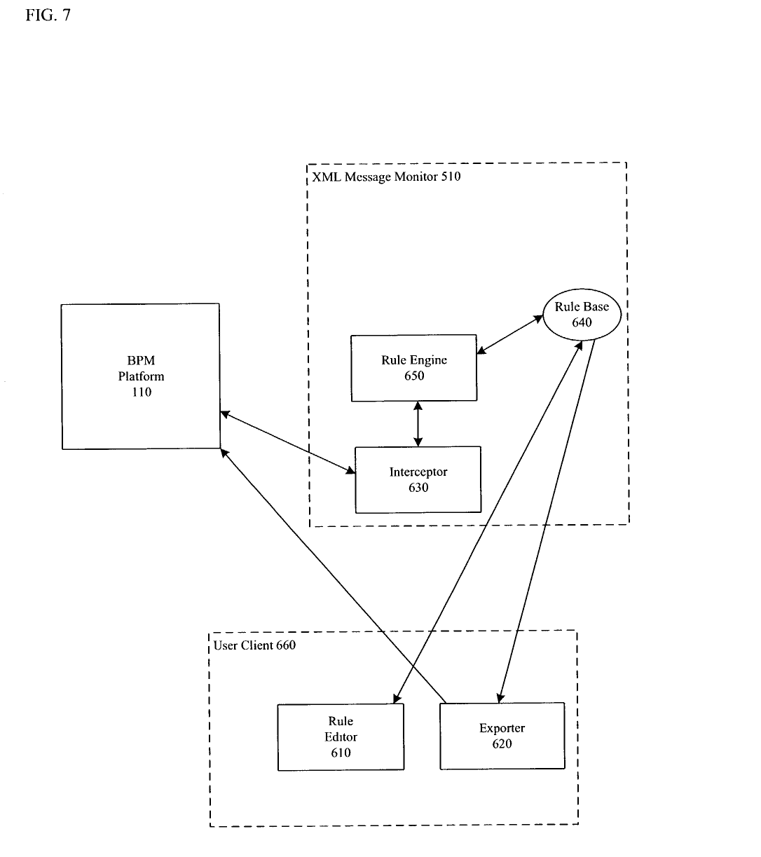

FIG. 7 depicts a block diagram of the salient components of XML message monitor 510 and user client 660, interconnected as shown, in accordance with the second illustrative embodiment of the present invention. In contrast to the first illustrative embodiment, rule editor 610 and exporter 620 reside at user client 660 (i.e., user client 660 is a “fat client”.) As is well-known in the art, a fat client can employ a sophisticated GUI with interactive features such as “drag-and-drop”. Consequently, in some instances of the second illustrative embodiment, rule editor 610 might employ an interactive GUI through which a user can build, edit, save, load, and delete rules, as is well-understood in the art, and similarly, exporter 620 might employ an interactive GUI through which a user can export rules to BPM platform 110. The basic functionality of rule editor 610 and exporter 620, as well as interceptor 630 and rule engine 650 (which do not employ any kind of user interface), is the same in the second illustrative embodiment as in the first illustrative embodiment.

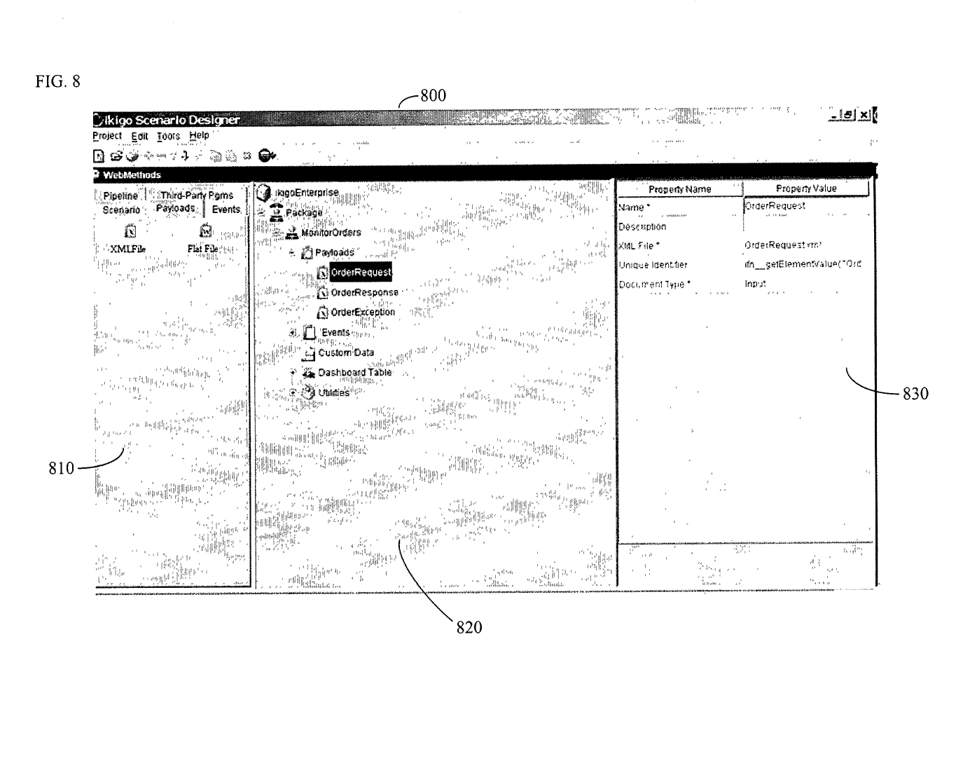

FIG. 8 depicts exemplary graphical user interface 800 for managing payloads, in accordance with the illustrative embodiments of the present invention. The term ‘payload’ refers to the contents of a message passed between applications. As shown in FIG. 8, GUI 800 comprises payload component subwindow 810, explorer subwindow 820, and property subwindow 830. Payload component subwindow 810 contains icons that a user can “drag-and-drop” to create new payloads, as is well known in the art. Explorer subwindow 820 shows an exemplary scenario MonitorOrders with three XML payloads: OrderRequest, OrderResponse, and OrderException. A ‘scenario’ is a kind of container for holding a plurality of items of different types, such as payloads, events (described below), etc.

XML payload OrderRequest is highlighted in explorer subwindow 820, indicating that a user has selected this payload by clicking on it. Property subwindow 830 shows a list of property name/value pairs for the selected payload, such as the payload name, the name of an XML file associated with the payload, etc.

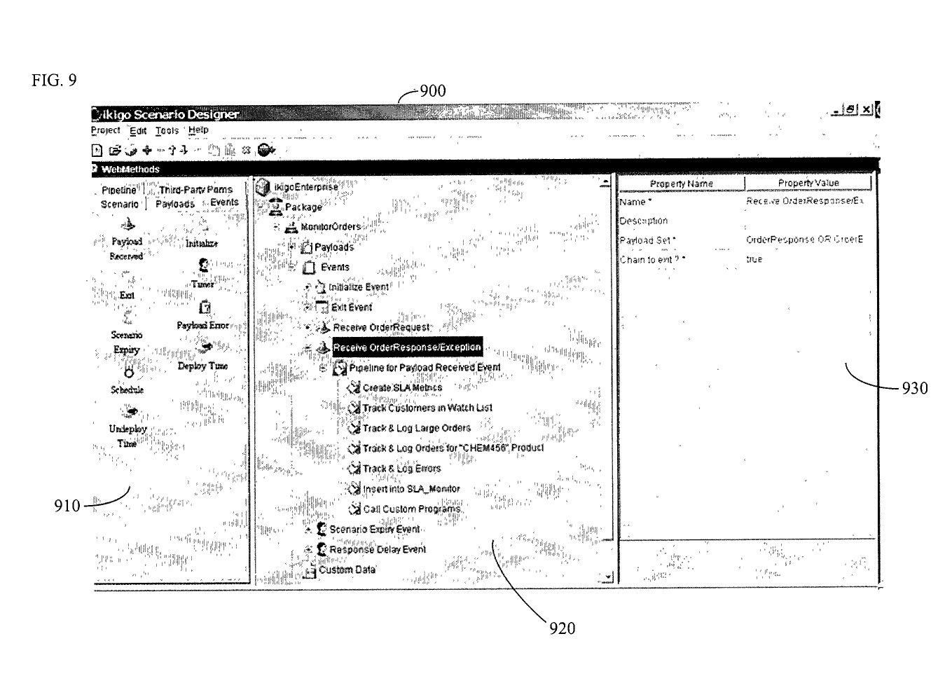

FIG. 9 depicts exemplary graphical user interface 900 for managing events, in accordance with the illustrative embodiments of the present invention. As is well-known in the art, events are occurrences in an asynchronous (e.g., distributed, etc.) system such as the receipt of a message, the expiration of a timeout, a scheduled event, etc. As shown in FIG. 9, GUI 900 comprises event component subwindow 910, explorer subwindow 920, and property subwindow 930. As is apparent in FIG. 9, subwindows 910, and 920, and 930 in exemplary GUI 900 closely correspond to subwindows 810, 820, and 830, in exemplary GUI 800, respectively. This correspondence aids in integrating multiple GUIs into a single coherent, easy-to-use interface; however, some embodiments may implement GUIs 800 and 900 in an alternative fashion, as will be understood by those skilled in the art.

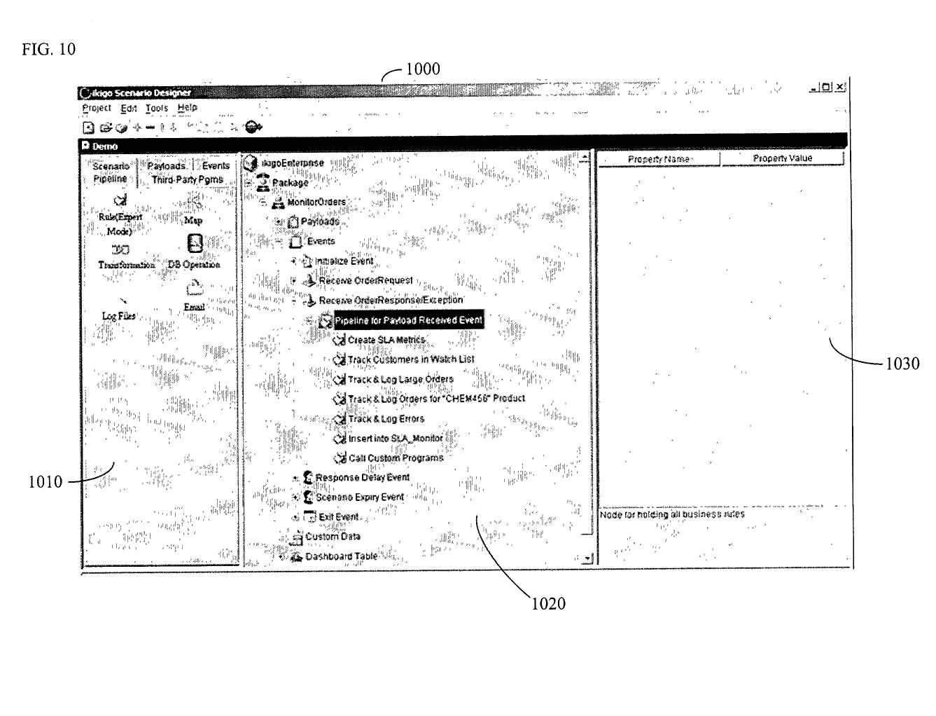

Event component subwindow 910 contains icons that a user can drag-and-drop to create new events, as is well known in the art. Explorer subwindow 920 shows an exemplary package MonitorOrders with six events: Initialize Event, Exit Event, Receive OrderRequest, Receive OrderResponseException, Scenario Expiry Event, and Response Delay Event. Event Receive OrderResponseException is highlighted in explorer subwindow 920, indicating that a user has selected this event by clicking on it. (As shown in explorer subwindow 920, event Receive OrderResponseException has an associated ‘pipeline’; pipelines are defined below in the description of FIG. 10.) Property subwindow 930 shows a list of property name/value pairs for the selected event, such as the event name, types of received payloads that trigger the event, etc.

FIG. 10 depicts an exemplary graphical user interface for managing pipelines, in accordance with the illustrative embodiments of the present invention. A ‘pipeline’ is a sequence of actions associated with a particular event, where an action refers to such entities as a rule, a mapping operation (disclosed below in the description of FIG. x), a database operation, sending an email, etc. Thus, a scenario, which contains at least one event and an associated pipeline of actions, corresponds to a subset of rule base 640, disclosed above.

As shown in FIG. 10, GUI 1000 comprises pipeline component subwindow 1010, explorer subwindow 1020, and property subwindow 1030. Pipeline component subwindow 1010 contains icons that a user can drag-and-drop to create new actions, as is well known in the art. Explorer subwindow 1020 shows exemplary pipeline Receive OrderResponseException with seven actions (all of which are rules, as indicated by the associated icons): Create SLA Metrics, Track Customers in Watch List, Track & Log Large Orders, Track & Log Orders for “CHEM456” Product, Track & Log Errors, Insert into SAL_Monitor, and Call Custom Programs. As in the previous GUIs, when a particular action is selected by clicking on the action, property subwindow 1030 displays a list of property name/value pairs for the selected action. For example, for a database operation, properties might include the database uniform resource locator (URL), login identifier, password, etc., while for sending an email, properties might include a list of destination email addresses, a priority, etc. When a rule in explorer subwindow 1020 is selected via double-clicking, GUI 1000 launches another GUI for rule editor 610 in a new window displayed on top of GUI 1000.

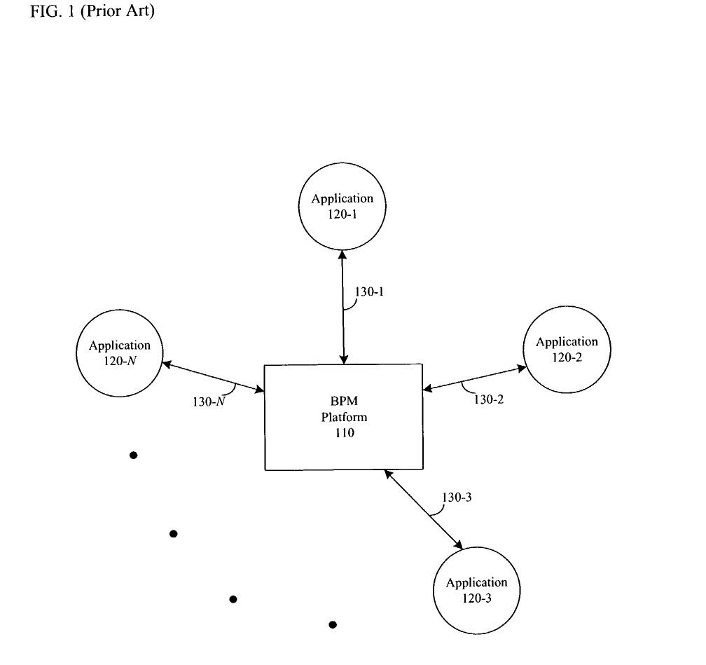

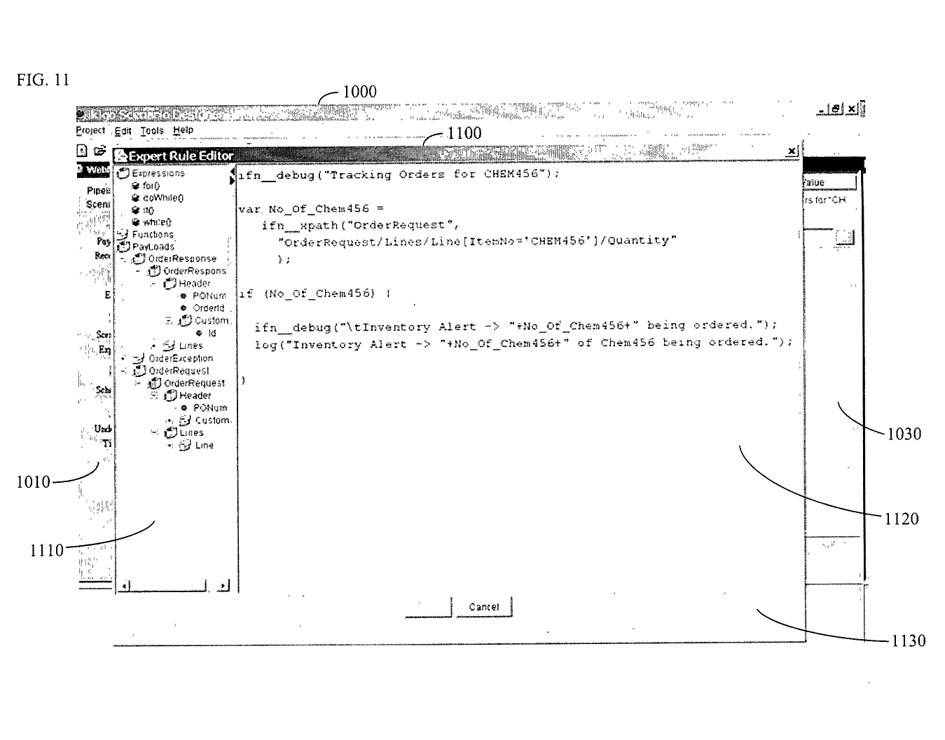

FIG. 11 depicts an exemplary GUI 1100 for rule editor 610 in accordance with the illustrative embodiments of the present invention. As shown in FIG. 1, GUI 1100 comprises explorer subwindow 1110, text editor subwindow 1120, and save subwindow 1130. Text editor subwindow 1120 accepts text input from a user for creating/modifying a selected rule, as is well-known in the art. In FIG. 1, text editor subwindow 1120 contains Javascript code corresponding to selected rule Track & Log Orders for “CHEM456” Product, as described above. Save subwindow 1130 has buttons enabling a user to save or cancel changes made to the selected rule, as is well-known in the art.

Explorer subwindow 1110 contains a list of payloads, as well as lists of imperative programming expressions (e.g., for, while, etc.) and functions, as are well-known in the art. A user can drag-and-drop any of the elements in explorer subwindow 1110 into text editor subwindow 1120 as shortcuts to building rules. into all of which a user can drag-and-drop into text editor subwindow 1120 Elements in subwindow 1110 can be drag-and-dropped

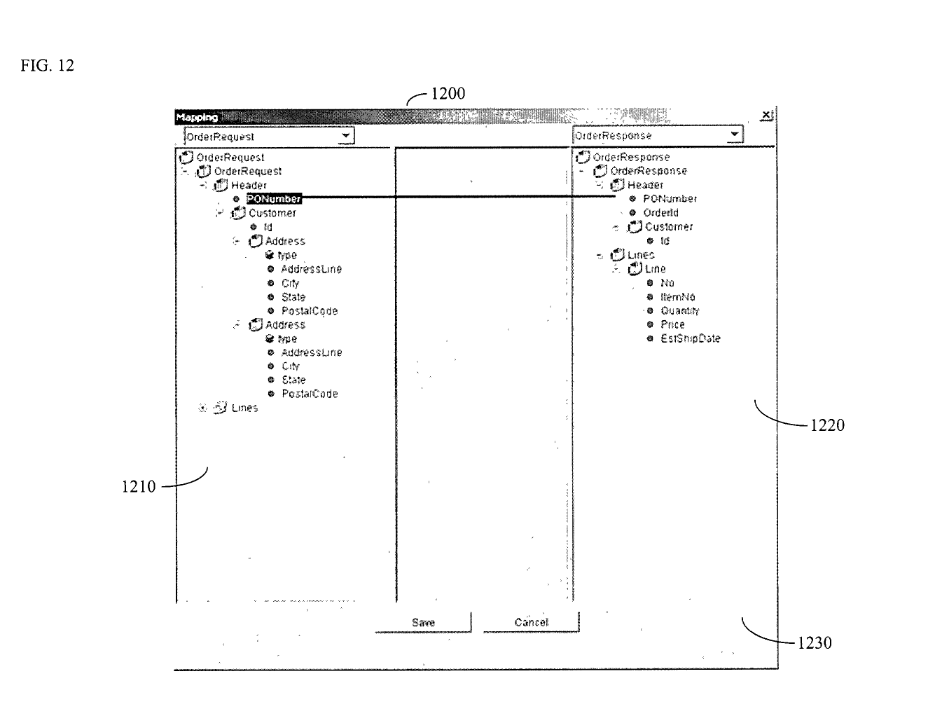

FIG. 12 depicts exemplary GUI 1200 for mapping payloads, in accordance with the illustrative embodiments of the present invention. Payload mapping is the matching of respective fields between two payloads, and is a mechanism for passing data between applications, rules in a pipeline, etc., as described above. As shown in FIG. 12, GUI 1200 comprises first payload drop-down list 1210, first payload subwindow 1220, second payload drop-down list 1230, second payload subwindow 1240, and save subwindow 1250. Payload drop-down lists 1210 and 1230 each contain a list of payloads in the current package, enabling a user to select two payloads for mapping. Payload subwindow 1220 displays a template that graphically depicts the hierarchical structure of the payload selected from payload drop-down list 1210. Similarly, payload subwindow 1240 displays a template corresponding to the payload selected from payload drop-down list 1230.

A user creates a mapping between a field of a first payload and a field of a second payload by graphically dragging-and-dropping the graphical depiction of the first payload's field in subwindow 1220 over to the graphical depiction of the second payload's field in subwindow 1240. This is similar to the way a user might copy a file from a first folder to a second folder in an GUI-based operating system (e.g., Microsoft Windows, etc.), as is well-known in the art. GUI 1200 indicates the presence of a mapping by displaying a graphical line connecting the two fields; for example, the line in FIG. 11 connecting field PONumber of payload OrderRequest and field PONumber of payload OrderResponse indicates a mapping between these fields. (Note that the names of the fields of a mapping are not required to be the same; when passing data from one application to another via payloads, for example, the mapped fields often have different names, as programmers for the two applications are often different and choose different field names for the same semantic concept.) Save subwindow 1250 enables a user to save or cancel mappings, as is well understood in the art.

FIG. 13 depicts first exemplary GUI screen 1300 for exporter 620, in accordance with the illustrative embodiments of the present invention. As shown in FIG. 13, GUI screen 1300 comprises drop-down list 1310, text field 1320, text field 1330, and button 1340. Drop-down list 1310 enables a user to specify a package; as is well-known in the art, the term ‘package’ denotes a container. In the illustrative embodiments of the present invention, a package contains one or more folders (i.e., directories). Text field 1320 enables a user to specify a folder name via manually entering text, as is well-known in the art. In some other embodiments, a ‘browse’ button linked to the file system, as is well-known in the art, might be used in lieu of text field 1330. Text field 1330 enables a user to specify a service name via manually entering text, as is well-known in the art. The service name is an identifier through which a scenario is invoked, and the combination of package and folder specifies the location of that service in a hierarchical file system, as is well-known in the art. A user clicks on button 1340 to advance to second screen 1400 for exporter 620, disclosed below.

FIG. 14 depicts second exemplary GUI screen 1400 for exporter 620, in accordance with the illustrative embodiments of the present invention. As shown in FIG. 14, GUI screen 1400 comprises drop-down list 1410 and button 1420. Drop-down list 1410 enables a user to specify the scenario for which a service (named according to text field 1330, disclosed above) will be generated. A user clicks on button 1420 to advance to third screen 1500 for exporter 620, disclosed below.

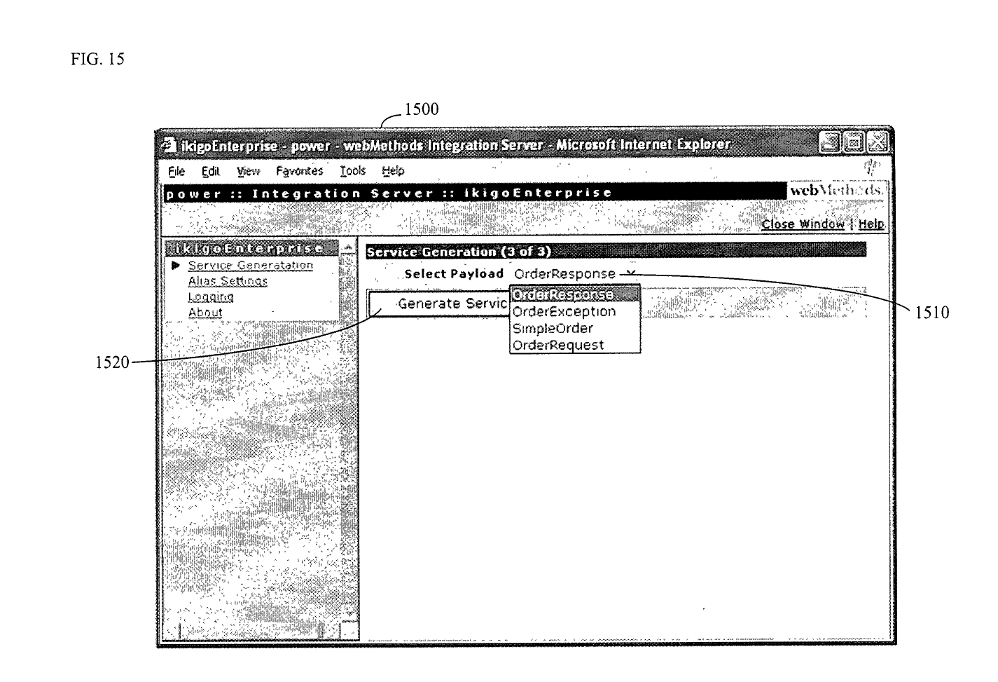

FIG. 15 depicts third exemplary GUI screen 1500 for exporter 620, in accordance with the illustrative embodiments of the present invention. As shown in FIG. 15, GUI screen 1500 comprises drop-down list 1510 and button 1520. Drop-down list 1510 enables a user to specify a payload corresponding to the ‘return value’ of the service, as is well-known in the art. A user clicks on button 1520 to generate the service, and export the service (and thus export the rules of the corresponding scenario) to BPM platform 110.

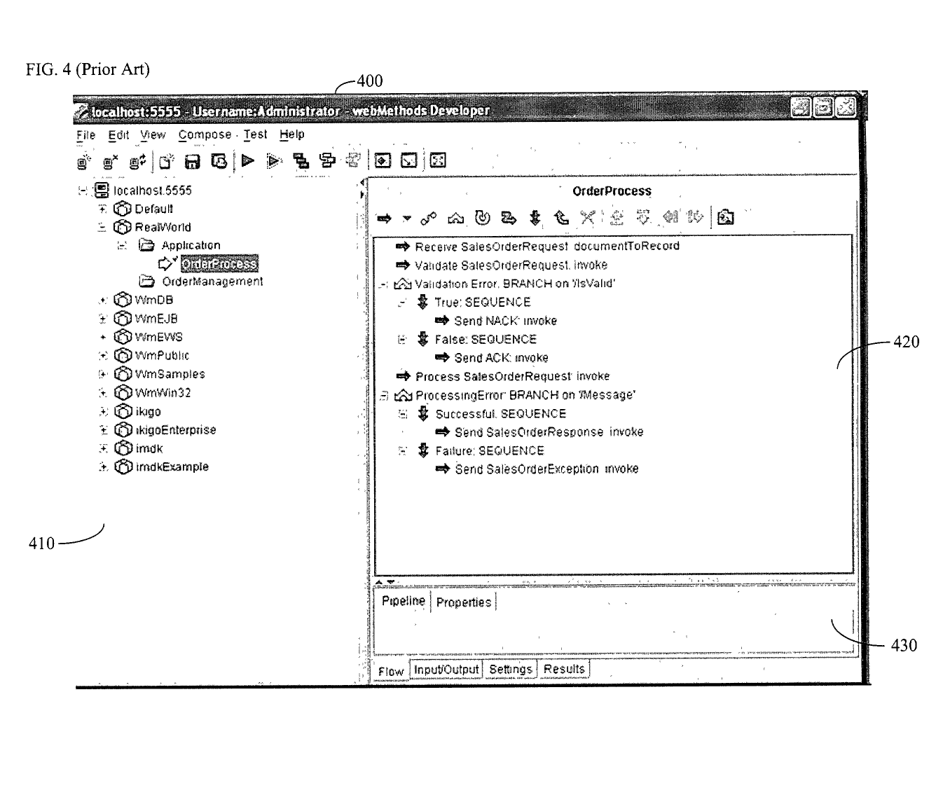

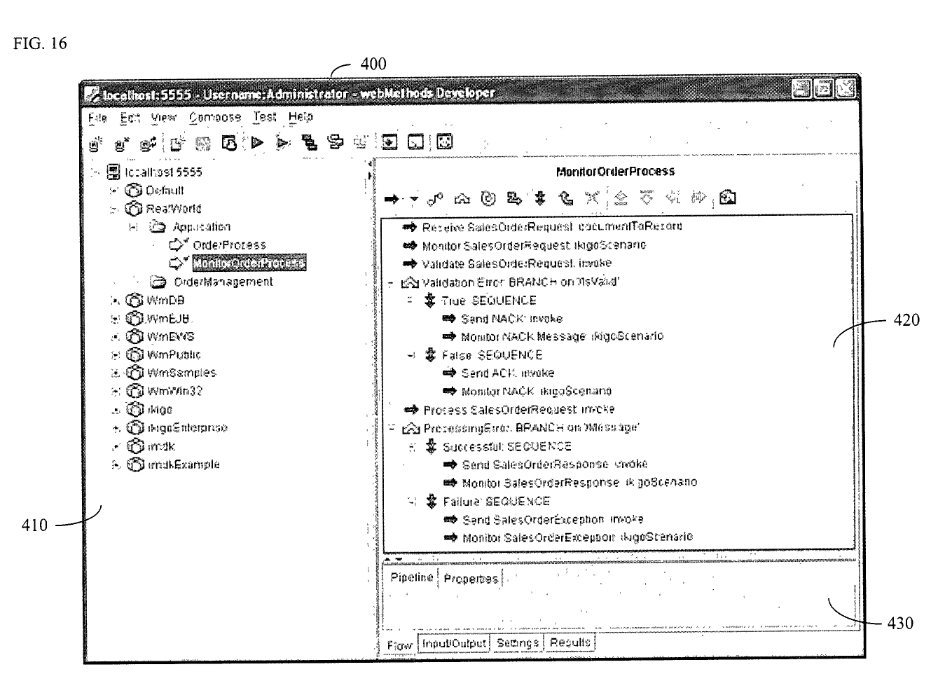

FIG. 16 depicts exemplary graphical user interface 400, disclosed above, for business process modeler 320 in accordance with the illustrative embodiments of the present invention. As shown in FIG. 16, folder Application in service list subwindow 410 contains service OrderProcess, as in FIG. 4, and also contains a new service MonitorOrderProcess that incorporates rules exported from exporter 620 to BPM platform 110. As shown in implementation subwindow 420 of FIG. 16, service MonitorOrderProcess comprises the statements of service OrderProcess, as shown in FIG. 4, augmented with a plurality of rules exported to BPM platform 110 by exporter 620: Monitor Sales OrderRequest, Monitor NACK Message, Monitor NACK, Monitor SalesOrderResponse, and Monitor SalesOrderException.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. An apparatus comprising:
an exporter for exporting a rule to a transaction editor, wherein said transaction editor is for defining a transaction, and wherein said transaction is based on said rule, and wherein said transaction is managed by a transaction manager, and wherein said rule comprises
a condition,
a possibly empty set of actions, and
a return value; and
an interceptor for
intercepting a message sent from a source to at least one destination, wherein said message is part of said transaction, and
when the contents of said message matches said rule's condition executing said set of actions when said set is non-empty, and transmitting said return value to said transaction manager;
wherein said transaction manager manages said transaction based on said return value.

2. The apparatus of claim 1 wherein the contents of said message is in a markup language.

3. The apparatus of claim 2 wherein said markup language is XML.

4. The apparatus of claim 1 wherein said return value is in a markup language.

5. The apparatus of claim 1 further comprising a rule editor for defining and editing said rule.

6. An apparatus comprising:
an exporter for exporting a rule to a business process modeler, wherein said business process modeler is for defining a business process, and wherein said business process is based on said rule, and wherein said business process is managed by a business process manager, and wherein said rule comprises
a condition,
a possibly empty set of actions, and
a return value; and
an interceptor for
intercepting a message sent from a source to at least one destination, wherein said message is part of said business process, and
when the contents of said message matches said rule's condition executing said set of actions when said set is non-empty, and transmitting said return value to said transaction manager;
wherein said business process manager manages said business process based on said return value.

7. The apparatus of claim 6 wherein the contents of said message is in a markup language.

8. The apparatus of claim 7 wherein said markup language is XML.

9. The apparatus of claim 6 wherein said return value is in a markup language.

10. The apparatus of claim 6 further comprising a rule editor for defining and editing said rule.

11. An apparatus comprising:
a transaction editor for defining a transaction;
a transaction manager for managing said transaction; and
an application for monitoring a message sent from a source to at least one destination, wherein said message is part of said transaction, and wherein said application is CHARACTERIZED BY:
a rule editor for defining and editing a rule, wherein said rule comprises
a condition,
a possibly empty set of actions, and
a return value;
an exporter for exporting said rule to said transaction editor, wherein said transaction is based on said rule; and
an interceptor for
intercepting said message, and
when the contents of said message matches said rule's condition executing said set of actions when said set is non-empty, and transmitting said return value to said transaction manager;
wherein said transaction manager manages said transaction based on said return value.

12. The apparatus of claim 11 wherein the contents of said message is in a markup language.

13. The apparatus of claim 12 wherein said markup language is XML.

14. The apparatus of claim 11 wherein said return value is in a markup language.

15. The apparatus of claim 11 wherein said rule editor has a graphical user interface.

16. An apparatus comprising:
a business process modeler for defining a business process;
a business process manager for managing said business process; and
an application for monitoring a message sent from a source to at least one destination, wherein said message is part of said business process, and wherein said application is CHARACTERIZED BY:
a rule editor for defining and editing a rule, wherein said rule comprises
a condition,
a possibly empty set of actions, and
a return value;
an exporter for exporting said rule to said business process modeler, wherein said business process is based on said rule; and
an interceptor for
intercepting said message, and
when the contents of said message matches said rule's condition executing said set of actions when said set is non-empty, and transmitting said return value to said business process manager;
wherein said business process manager manages said business process based on said return value.

17. The apparatus of claim 16 wherein said message is sent via a messaging platform.

18. The apparatus of claim 16 wherein said business process modeler and said business process manager are part of an integration platform.

19. The apparatus of claim 18 wherein said message is sent via an adapter.

20. The apparatus of claim 16 wherein the contents of said message is in a markup language.

21. The apparatus of claim 20 wherein said markup language is XML.

22. The apparatus of claim 16 wherein said return value is in a markup language.
